(19) United States
(12) Patent Application Publication
(10) Pub. No.: US 2025/0313225 A1
(43) Pub. Date: Oct. 9, 2025

(54) NOTIFICATION DEVICE

(71) Applicant: TOYOTA JIDOSHA KABUSHIKI KAISHA, Toyota-shi (JP)

(72) Inventors: Shingo SAKAIDA, Soka-shi (JP); Kenta Kumazaki, Tokyo (JP)

(73) Assignee: TOYOTA JIDOSHA KABUSHIKI KAISHA, Toyota-shi (JP)

(21) Appl. No.: 19/073,202

(22) Filed: Mar. 7, 2025

(30) Foreign Application Priority Data
Apr. 9, 2024 (JP) 2024-062850

(51) Int. Cl. B60W 50/14; B60W 50/02; B60W 60/00

(52) U.S. Cl. CPC B60W 50/14; B60W 50/0205; B60W 60/00; B60W 2556/10

(57) ABSTRACT

A notification device of a vehicle comprising a malfunction recognition unit configured to recognize a malfunction of an external sensor used for driving assistance control or autonomous driving control; and a notification control unit configured to notify an occupant of the vehicle about the malfunction of the external sensor when a malfunction of the external sensor is recognized. The notification control unit evaluates whether the vehicle is likely to travel on a target road based on a vehicle position, a target route, or a travel history of the vehicle; and when the vehicle is not likely to travel on the target road, notifies the occupant of the vehicle about the malfunction of the external sensor in a reduced manner compared to a manner when the vehicle is likely to travel on the target road, or does not notify the occupant of the vehicle about the malfunction of the external sensor.

### CROSS-REFERENCE TO RELATED APPLICATION

This application is based upon and claims the benefit of priority from Japanese Patent Application No. 2024-062850, filed on Apr. 9, 2024, the entire contents of which are incorporated herein by reference.

### TECHNICAL FIELD

The present disclosure relates to a notification device.

### BACKGROUND

Vehicle control systems have been disclosed that include a regulation module that defines an Operational Design Domain (ODD) of a vehicle, and a control module that controls the operation of the vehicle based on the ODD.

### SUMMARY

Conventionally, in vehicles capable of executing driving assistance control or autonomous driving control on a target road, notifications regarding malfunctions of external sensors may be provided. Malfunctions of external sensors include temporary malfunctions such as adhesion of water droplets to the external sensors. If such temporary malfunctions of external sensors are notified, for example, when the vehicle is not located on the target road, there is a possibility of causing annoyance and anxiety to an occupant of the vehicle.

An example of the present disclosure is a notification device of a vehicle capable of executing driving assistance control or autonomous driving control on a target road, including: a malfunction recognition unit configured to recognize a malfunction of an external sensor used for the driving assistance control or the autonomous driving control; and a notification control unit configured to notify an occupant of the vehicle about the malfunctions of the external sensors when a malfunction of an external sensor is recognized. The notification control unit evaluates whether the vehicle is likely to travel on the target road based on a vehicle position, a target route, or a travel history of the vehicle; and when the vehicle is not likely to travel on the target road, notifies the occupant of the vehicle about the malfunction of the external sensor in a reduced manner compared to a manner when the vehicle is likely to travel on the target road, or does not notify the occupant of the vehicle about the malfunction of the external sensor.

In the notification device according to an example of the present disclosure, when the vehicle is not likely to travel on the target road, the malfunction of the external sensors is notified in a reduced manner, or the malfunction of the external sensors is not notified. This suppresses the notification of malfunctions of external sensors when the vehicle is not likely to travel on the target road. As a result, it is possible to suppress causing annoyance and anxiety to the occupant due to temporary malfunctions of the external sensors.

In an example, the notification control unit may evaluate that the vehicle is not likely to travel on the target road when the target road is not included in the target route, or when the vehicle position is at or more than a predetermined distance threshold away from the target road. In this case, it is possible to evaluate a likelihood of the vehicle traveling on the target road based on whether or not the target road is included in the target route, or whether or not the vehicle position is at or more than a predetermined distance threshold away from the target road.

In an example, the notification control unit may estimate, based on past travel history, a probability that the vehicle travels on the target road at a timing corresponding to the same day and time period of the week, and may evaluate that the vehicle is not likely to travel on the target road when the probability is less than a predetermined probability threshold. In this case, it is possible to evaluate a likelihood of the vehicle traveling on the target road according to the probability that the vehicle travels on the target road at a timing corresponding to the same day and time period of the week.

In an example, the notification control unit may estimate, based on past travel history, a probability that the vehicle travels on the target road at a corresponding timing during a holiday period, and may evaluate that the vehicle is not likely to travel on the target road when the probability is less than a predetermined probability threshold. In this case, it is possible to evaluate a likelihood of the vehicle traveling on the target road according to the probability that the vehicle travels on the target road at a corresponding timing during a holiday period.

In an example, the notification control unit may estimate, based on schedule information including a destination of the occupant obtainable from an information terminal carried by the occupant, a probability that the vehicle travels on the target road along the target route to the destination, and may evaluate that the vehicle is not likely to travel on the target road when the probability is less than a predetermined probability threshold. In this case, it is possible to evaluate a likelihood of the vehicle traveling on the target road by utilizing schedule information including the destination.

According to various aspects of the present disclosure, it is possible to suppress causing annoyance and anxiety to an occupant due to temporary malfunctions of the external sensors.

### BRIEF DESCRIPTION OF THE DRAWINGS

FIG. 1 is a functional block diagram illustrating an example of a vehicle including an example of a notification device.

FIG. 2A is a diagram for explaining learning of the probability that the vehicle travels on the target road at a timing corresponding to the same day and time period of the week.

FIG. 2B is a diagram for explaining learning of the probability that the vehicle travels on the target road at a timing corresponding to the same day and time period of the week.

FIG. 3A is a diagram for explaining learning of the probability that the vehicle travels on the target road at a corresponding timing during a holiday period.

FIG. 3B is a diagram for explaining learning of the probability that the vehicle travels on the target road at a corresponding timing during a holiday period.

FIG. 4 is a diagram for explaining learning of the probability that the vehicle travels on the target road along a target route to a destination based on schedule information including the occupant's destination obtainable from an information terminal carried by the occupant.

FIG. 5 is a flowchart showing an example of processing of the notification device.

FIG. 6 is a flowchart showing an example of likelihood evaluation processing of FIG. 5.

### DETAILED DESCRIPTION

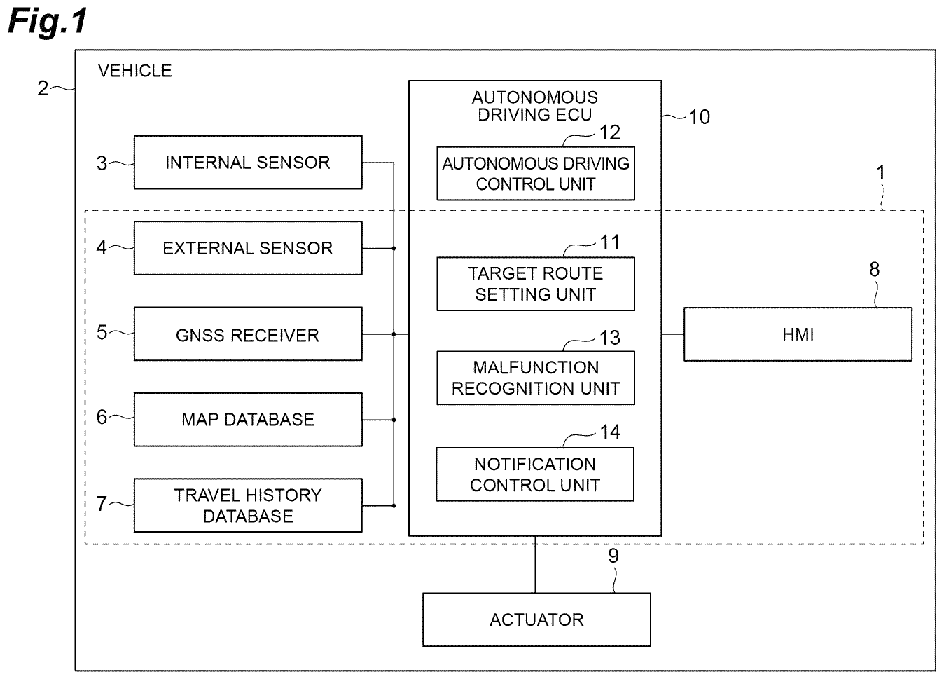

Hereinafter, exemplary examples will be described with reference to the drawings. In the following description, the same or corresponding elements are denoted by the same reference numerals, and redundant description may be omitted.

[Configuration of Vehicle and Notification Device] FIG. 1 is a functional block diagram illustrating an example of a vehicle including an example of a notification device. As shown in FIG. 1, a notification device 1 is mounted on a vehicle 2, such as a passenger car, and notifies information to an occupant of the vehicle. The vehicle 2 is a vehicle equipped with a vehicle control system capable of executing driving assistance control or autonomous driving control on a target road. The target road is a road included in the operation design domain (ODD) of the vehicle control system capable of executing driving assistance control or autonomous driving control. The ODD is a range in which the vehicle control system operates as designed. As an example, the ODD may cover motorways such as Interstate Highways, Freeways, and Expressways.

The vehicle 2 includes, as an example, an autonomous driving system. The autonomous driving system drives the vehicle 2 autonomously on roads included in the ODD. Autonomous driving is a driving state in which the vehicle 2 is automatically driven along the road on which the vehicle 2 is traveling. Autonomous driving includes, for example, a driving state in which the vehicle 2 is automatically driven toward a preset destination without a driving operation by the driver. Autonomous driving includes, for example, autonomous driving levels 2 to 4 in SAE (Society of Automotive Engineers) J3016. The destination may be set by an occupant such as the driver, or may be automatically set by the vehicle 2. In autonomous driving, the driver does not need to perform driving operations, and the vehicle 2 travels automatically.

The vehicle 2 includes an internal sensor 3, an external sensor 4, a GNSS receiver 5, a map database 6, a travel history database 7, an HMI (Human Machine Interface) 8, an actuator 9, and an autonomous driving ECU (Electronic Control Unit) 10.

The internal sensor 3 is a detection device that detects the traveling state of the vehicle 2. The internal sensor 3 includes a vehicle speed sensor. The vehicle speed sensor is a detector that detects the speed of the vehicle 2. As the vehicle speed sensor, for example, a wheel speed sensor that detects the rotational speed of a wheel of the vehicle 2 or a drive shaft that rotates integrally with the wheel is used. The internal sensor 3 may include an acceleration sensor and a yaw rate sensor. The internal sensor 3 transmits detection information about the traveling state of the vehicle 2 to the autonomous driving ECU 10.

The external sensor 4 includes at least either a camera or a radar sensor. The camera is an imaging device that images the surrounding environment of the vehicle 2. The camera is provided, for example, on the back side of a windshield of the vehicle 2 and captures images in front of the vehicle. The radar sensor is a detection device that detects objects around the vehicle 2 using radio waves (for example, millimeter waves) or light. The radar sensor includes, for example, a radar (millimeter wave radar) or a LiDAR (Light Detection And Ranging). The external sensor 4 transmits detection information about objects around the vehicle 2 to the autonomous driving ECU 10.

The GNSS receiver 5 receives signals from positioning satellites to measure the position of the vehicle 2 (for example, the latitude and longitude of the vehicle 2). The GNSS receiver 5 transmits the measured position information of the vehicle 2 to the autonomous driving ECU 10.

The map database 6 is a storage device that stores map information. The map database 6 is formed, for example, in a storage medium such as an HDD (Hard Disk Drive) mounted on the vehicle 2. The map information includes position information of roads, information of road shapes (for example, types of curves, straight sections, curvature radius of curves, shapes of intersections, lane widths, conditions of road shoulders outside the roadway, emergency parking zones, etc.), position information of intersections and branch points, and position information of structures. The map database 6 may be formed in a server that can communicate with the vehicle 2.

The travel history database 7 is a database that stores the travel history of the vehicle 2. The travel history is a history of positions on the map where the vehicle 2 has traveled in the past. The travel history database 7 may be stored in a server that can communicate with the vehicle 2.

The HMI 8 is an interface for inputting and outputting information between the autonomous driving ECU 10 and the occupant. The HMI 8 includes, for example, a display, a speaker, and a microphone provided in the vehicle cabin. The HMI 8 performs image output on the display and audio output from the speaker according to control signals from the autonomous driving ECU 10. The display may function as a touch panel. The display may be a center display, a navigation display, or a HUD (Head Up Display). The HUD projects images onto the windshield of the vehicle 2 to present information to the occupant.

The HMI 8 presents information about malfunctions of the external sensor 4 to the occupant. The information about malfunctions of the external sensor 4 may be presented to the occupant by image output or by audio output. The image output can be a pop-up display including text information such as “Autonomous driving is not available. System malfunction” on the speedometer screen. The image output may be an indicator display using a predetermined icon representing a malfunction of the external sensor 4.

The actuator 9 is a device used for traveling control of the vehicle 2 and operates in response to control signals from the autonomous driving ECU 10. The actuator 9 includes at least a drive actuator, a brake actuator, and a steering actuator. The drive actuator is provided in, for example, an engine or an electric motor as a power source, and controls the driving force of the vehicle 2. The brake actuator is provided in a hydraulic brake system, for example, and controls the braking force applied to the wheels of the vehicle 2. The steering actuator is, for example, an assist motor of an electric power steering system, and controls steering torque of the vehicle 2.

The autonomous driving ECU 10 controls the autonomous driving system. The autonomous driving ECU 10 is an electronic control unit having a CPU (Central Processing Unit) and a storage unit. The storage unit is composed of, for example, ROM (Read Only Memory), RAM (Random Access Memory), EEPROM (Electrically Erasable Programmable Read-Only Memory), and the like. The autonomous driving ECU 10 realizes various functions by executing programs stored in the storage unit with the CPU. The autonomous driving ECU 10 may be composed of a plurality of electronic units.

The functions of the autonomous driving ECU 10 will be described below. As shown in FIG. 1, the autonomous driving ECU 10 has a target route setting unit 11, an autonomous driving control unit 12, a malfunction recognition unit 13, and a notification control unit 14 as functional configurations. The functions of the autonomous driving ECU 10 may be realized by using a server that can communicate with the vehicle 2. Among these functional configurations, at least the malfunction recognition unit 13 and the notification control unit 14 form the notification device 1.

The target route setting unit 11 sets a target route for guiding the vehicle 2 to a preset destination. The target route is a route on the map from the vehicle position measured by the GNSS receiver 5 to the destination. The target route setting unit 11 recognizes the road and traveling lane on which the vehicle 2 travels based on the vehicle position measured by the GNSS receiver 5 and the map information of the map database 6. The target route setting unit 11 may use the function of the navigation system of the vehicle 2.

The target route may be a road included in the ODD or a road not included in the ODD. When the target route is a road included in the ODD, the portion of the target route included in the ODD can be used to generate the trajectory of the vehicle 2 for executing autonomous driving. When the target route is a road not included in the ODD, autonomous driving is not executed, but the target route may be displayed on the display of the HMI 8 to guide the driver.

The target route setting unit 11 may set the target route using the destination input by the occupant via the HMI 8. The target route setting unit 11 may obtain the destination of the occupant from an information terminal carried by the occupant with the occupant's permission. The target route setting unit 11 may obtain the destination associated with the user's schedule information of a smartphone carried by the occupant using a communication unit that communicates directly or via a communication network with the smartphone. The user's schedule information may be recorded in the user's smartphone or may be recorded on a cloud service accessible from the user's smartphone.

The target route setting unit 11 stores the route actually traveled by the vehicle 2 in the past as a travel history in the travel history database 7 according to the past vehicle positions. The target route setting unit 11 stores, for example, whether or not the vehicle 2 has traveled on roads included in the ODD in the past, in association with the date and time, as a travel history in the travel history database 7. The target route setting unit 11 may store, instead of based on past vehicle positions, whether or not the target route used in the past is a road included in the ODD as a travel history in the travel history database 7.

The autonomous driving control unit 12 recognizes objects around the vehicle 2 (including the positions of the objects) based on at least one of the detection result of the external sensor 4 and the map database 6. The objects include stationary objects that do not move, such as utility poles, guardrails, trees, and buildings, as well as dynamic objects such as pedestrians, bicycles, and other vehicles. The autonomous driving control unit 12 recognizes objects, for example, each time a detection result is obtained from the external sensor 4. The autonomous driving control unit 12 recognizes objects around the vehicle 2 based on the detection result of the external sensor 4 (imaging information of the camera, object detection result of the radar sensor), for example, using pattern matching or a machine learning model. The autonomous driving control unit 12 may recognize objects around the vehicle 2 by other known methods.

The autonomous driving control unit 12 recognizes the traveling state of the vehicle 2 based on the detection result of the internal sensor 3 (for example, vehicle speed information of the vehicle speed sensor, acceleration information of the acceleration sensor, yaw rate information of the yaw rate sensor, etc.). The traveling state of the vehicle 2 includes, for example, vehicle speed, acceleration, and yaw rate.

The autonomous driving control unit 12 recognizes the position of the vehicle 2 on the map (vehicle position) based on the detection result of the external sensor 4, the position information by the GNSS receiver 5, and the map information of the map database 6. The autonomous driving control unit 12 may recognize the position of the vehicle 2 by SLAM (Simultaneous Localization And Mapping) technology using the position information of stationary objects such as utility poles included in the map information of the map database 6 and the detection result of the external sensor 4. The autonomous driving control unit 12 may recognize the vehicle position by other known methods.

The autonomous driving control unit 12 generates a trajectory of the vehicle 2 to automatically travel along the target route based on, for example, the target route, the detection result of the external sensor 4, the map information of the map database 6, the recognized vehicle position, the information of the recognized objects, and the recognized traveling state of the vehicle 2. The autonomous driving control unit 12 generates a travel plan according to the trajectory of the vehicle 2 based on, for example, the detection result of the external sensor 4 and the map database 6. The travel plan is not particularly limited as long as it describes the behavior of the vehicle 2. The autonomous driving control unit 12 may generate a speed plan within a range that does not exceed the speed limit of the traveling lane using the speed limit stored in the map database 6 as part of the travel plan of the vehicle 2.

The autonomous driving control unit 12 automatically controls the travel of the vehicle 2 based on the generated travel plan when the vehicle position is located on a road included in the ODD. The autonomous driving control unit 12 outputs control signals corresponding to the travel plan to the actuator 9. Thus, the autonomous driving control unit 12 controls the travel of the vehicle 2 so that the vehicle 2 automatically travels along the trajectory. On the other hand, the autonomous driving control unit 12 does not execute autonomous driving when the vehicle position is not located on a road included in the ODD.

The malfunction recognition unit 13 recognizes a malfunction of the external sensor 4 used for driving assistance control or autonomous driving control. A malfunction of the external sensor 4 is a malfunction occurring in the function of the external sensor 4. An example of a malfunction of the external sensor 4 is a malfunction of the function of the external sensor 4 that makes it impossible to execute autonomous driving, or a malfunction of the function of the external sensor 4 that makes it impossible to continue autonomous driving without a fallback function using an alternative means. Such malfunctions include, for example, an actual malfunction of the external sensor 4 itself and a decrease in function due to foreign matter adhering to the external sensor 4.

The actual malfunction of the external sensor 4 itself includes a physical malfunction of the external sensor 4 itself and a malfunction in the internal processing of the external sensor 4 itself. The foreign matter adhering to the external sensor 4 may be an object such as water droplets, water stains, or mud adhering to the window portion facing the outside of the external sensor 4. For example, water droplets may adhere to the window portion facing the outside of the external sensor 4 during rainy weather with a large amount of precipitation or after washing with a car wash machine. A decrease in function due to foreign matter adhering to the external sensor 4 can be considered a temporary malfunction of the external sensor 4.

The malfunction recognition unit 13 can recognize the presence or absence of these malfunctions of the external sensor 4 by known methods. However, the malfunction recognition unit 13 recognizes a decrease in function due to foreign matter adhering to the external sensor 4 as the presence or absence of a malfunction of the external sensor 4 similar to an actual malfunction, without distinguishing it from other actual malfunctions of the external sensor 4, or misrecognizes it.

The notification control unit 14 notifies the occupant of the vehicle about the malfunction of the external sensor 4 when a malfunction of the external sensor 4 is recognized. The notification control unit 14 may perform a pop-up display including text information such as “Autonomous driving is not available. System malfunction” on the speedometer screen of the HMI 8 when a malfunction of the external sensor 4 is recognized. The notification control unit 14 may perform an indicator display using a predetermined icon representing a malfunction of the external sensor 4 on the display of the HMI 8 when a malfunction of the external sensor 4 is recognized.

The notification control unit 14 evaluates whether the vehicle 2 is likely to travel on the target road (ODD) based on the vehicle position, the target route, or the travel history. The evaluation of the likelihood will be described later.

The notification control unit 14 notifies the occupant of the vehicle 2 about the malfunction of the external sensor 4 in a reduced manner compared to a manner when the vehicle 2 is likely to travel on the target road when the vehicle 2 is not likely to travel on the target road. The “reduced manner” means a manner in which the degree of urgency given to the occupant of the vehicle 2 is reduced. The “reduced manner” may use text information such as “Autonomous driving is temporarily restricted.” or “Please check the external sensor.” instead of text information such as “Autonomous driving is not available. System malfunction.” The “reduced manner” may perform only an indicator display using an icon without performing a pop-up display including text information on the speedometer screen of the HMI 8. Alternatively, the notification control unit 14 may not notify the occupant of the vehicle 2 about the malfunction of the external sensor 4 when the vehicle 2 is not likely to travel on the target road.

As an example of the evaluation of the likelihood, the notification control unit 14 evaluates that the vehicle 2 is not likely to travel on the target road when the ODD is not included in the target route. The case where the ODD is not included in the target route is, for example, when a navigation setting (destination setting, waypoint setting, etc.) is made so that the vehicle 2 does not travel on the target road.

The notification control unit 14 may evaluate that the vehicle 2 is not likely to travel on the target road when the vehicle position is at or more than a predetermined distance threshold away from the ODD. The distance threshold is a predetermined distance threshold for evaluating the likelihood of the vehicle 2 traveling on the target road. The notification control unit 14 may evaluate that the vehicle 2 is not likely to travel on the target road when the vehicle position is at or more than a predetermined distance threshold (for example, several kilometers) away from the nearest interchange of the motorways.

The notification control unit 14 may estimate the probability that the vehicle travels on the target road from a predetermined perspective and evaluate that the vehicle is not likely to travel on the target road when the estimated probability is less than a predetermined probability threshold. The probability threshold is a predetermined probability threshold for evaluating the likelihood of the vehicle 2 traveling on the target road. The notification control unit 14 may evaluate that the vehicle 2 is not likely to travel on the target road when the estimated probability is less than the probability threshold.

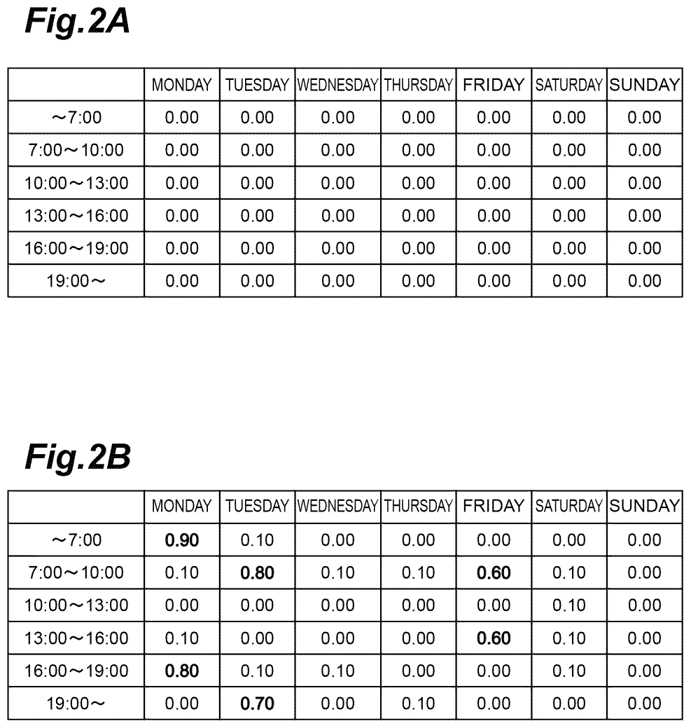

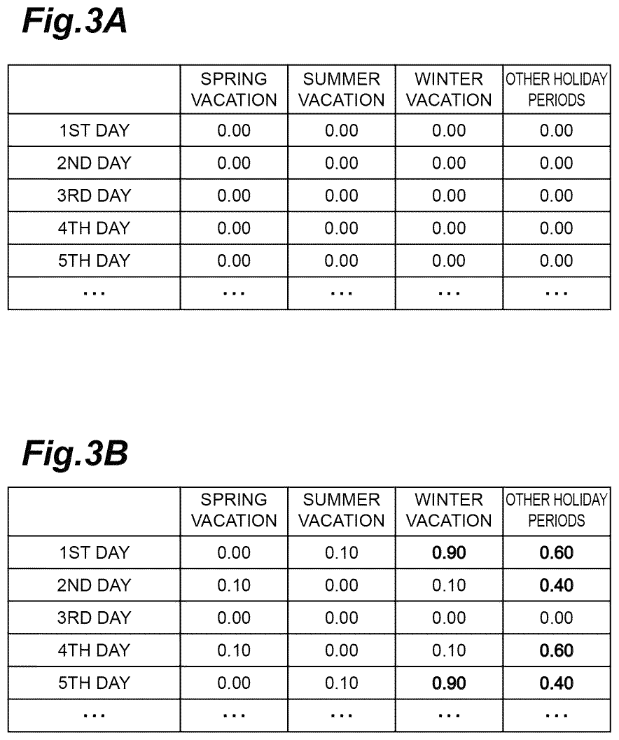

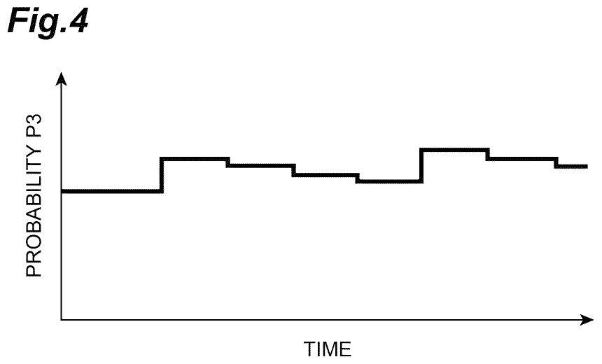

The notification control unit 14 estimates the probability P1 that the vehicle travels on the target road at a timing corresponding to the same day and time period of the week based on past travel history. The notification control unit 14 estimates the probability P2 that the vehicle travels on the target road at a corresponding timing during a holiday period based on past travel history. The notification control unit 14 estimates the probability P3 that the vehicle travels on the target road along the target route to the destination based on schedule information including the destination of the occupant obtainable from an information terminal carried by the occupant. The formula for calculating the probability P corresponding to the likelihood that the vehicle 2 travels on the target road estimated from these probabilities may be, for example, the following formula (1). The probabilities P1, P2, and P3 are estimated based on the learning results of FIG. 2A and FIG. 2B, FIG. 3A and FIG. 3B, and FIG. 4, respectively. α, β, and γ are weighting coefficients for weighting the probabilities P1, P2, and P3, and may have a relationship of α>β>γ.

$$P = α P 1 + β P 2 + γ P 3 \qquad ( 1 )$$

FIG. 2A and FIG. 2B are diagrams for explaining learning of the probability that the vehicle travels on the target road at a timing corresponding to the same day and time period of the week. FIG. 2A shows an example of the probability P1 before learning. FIG. 2B shows an example of the probability P1 after learning. FIG. 2A and FIG. 2B show an example of learning the probability that the vehicle 2 travels on the target road (for example, motorways) at each time period on each day of the week. Such learning may be performed for each vehicle 2. The notification control unit 14 calculates the probability P1 of the above formula (1) using this learning result.

As shown in the table of FIG. 2A and FIG. 2B, the probability P1 that the vehicle 2 is estimated to travel on the motorways on the estimated day is individually stored in each frame for each day of the week and each time period based on past travel history including vehicle position, map information, and date and time. The initial value of the probability P1 may be zero as shown in FIG. 2A.

The probability P1 in each frame may increase by Δp1 (for example, 0.1) each time the vehicle 2 travels on the motorways once in the corresponding day and time period of the week. The probability P1 in each frame may decrease by Δpd1 (for example, 0.01) if the vehicle 2 does not travel on the motorways for a certain period.

In the learning example of FIG. 2A and FIG. 2B, the following situations may be reflected. The driver of the vehicle 2 regularly commuted using the motorways from morning to evening on Mondays, Tuesdays, and Fridays. The driver of the vehicle 2 had a lower commuting frequency on Fridays than on Mondays and Tuesdays, for example, due to vacation or working from home. The driver of the vehicle 2 rarely used the motorways on Wednesdays and Thursdays, for example, due to business trips or working from home. The driver of the vehicle 2 occasionally took long trips using the motorways on Saturdays on weekends.

In this way, the results of daily travel history are accumulated as the probability P1 in each frame, and learning progresses. The value in the frame corresponding to the day and time period of the week on the estimated day is read out, and the weighting coefficient α is accumulated and used for the calculation of the above probability P.

FIG. 3A and FIG. 3B are diagrams for explaining learning of the probability that the vehicle travels on the target road at a corresponding timing during a holiday period. FIG. 3A shows an example of the probability P2 before learning. FIG. 3B shows an example of the probability P2 after learning. FIG. 3A and FIG. 3B show an example of learning the probability that the vehicle 2 travels on the target road (for example, motorways) on which day of each holiday period with preset periods and days. Such learning may be performed for each vehicle 2. The notification control unit 14 calculates the probability P2 of the above formula (1) using this learning result.

As shown in the table of FIG. 3A and FIG. 3B, the probability P2 that the vehicle 2 is estimated to travel on the motorways on the estimated day is individually stored in each frame corresponding to which day of each holiday period based on past travel history including vehicle position, map information, and date and time. The initial value of the probability P2 may be zero as shown in FIG. 3A.

The probability P2 in each frame may increase by Δp2 (for example, 0.1) each time the vehicle 2 travels on the motorways once in the frame corresponding to which day of each holiday period. The probability P2 in each frame may decrease by Δpd2 (for example, 0.01) if the vehicle 2 does not travel on the motorways for a certain period.

In the learning example of FIG. 3A and FIG. 3B, when taking the holiday periods in Japan as an example, the following situations may be reflected. The driver of the vehicle 2 regularly took long trips using the motorways on the first and fifth days for returning to his or her hometown and U-turns during the winter vacation at the end of the year and New Year. The driver of the vehicle 2 rarely used the motorways during the spring and summer vacations for children or students, for example, because work was usually a working day. Other holiday periods include the Golden Week (a series of national holidays) in May as an example of the holiday periods in Japan. In this case, the driver of the vehicle 2 regularly took long trips using the motorways on the first, second, fourth, and fifth days of the Golden Week in May.

The holiday periods in FIG. 3A and FIG. 3B may be, for example, the period of Spring Break, the period of Summer Vacation, the period of Winter Break including Christmas holidays, and other holiday periods when taking the holiday periods in the United States as an example. Other holiday periods may be, for example, a certain period including holidays and a continuous number of days when there is a certain possibility that Americans will take holidays before and after the holidays. Holidays in the United States may include, for example, Thanksgiving Day, Independence Day, and the like. In the learning example in the United States, the usage status of the motorways such as Interstate Highways, Freeways, and Expressways may be reflected.

In this way, the results of travel history during large holiday periods are accumulated as the probability P2 in each frame, and learning progresses. The value in the frame corresponding to the holiday period and which day of the estimated day is read out, and the weighting coefficient β is accumulated and used for the calculation of the above probability P.

FIG. 4 is a diagram for explaining learning of the probability that the vehicle travels on the target road along a target route to a destination based on schedule information including the occupant's destination obtainable from an information terminal carried by the occupant. The probability P3 is learned according to whether or not the driver of the vehicle 2 traveled on the motorways with the vehicle 2 according to the schedule information of the driver of the vehicle 2. The probability P3 may increase by Δp3 (for example, 0.1) each time the vehicle 2 travels on the motorways once according to the target route to the destination obtained from the schedule information. The probability P3 may decrease by Δpd3 (for example, 0.01) if the vehicle 2 does not travel on the motorways once, contrary to the schedule.

In this way, the actual results of whether or not the driver of the vehicle 2 traveled on the motorways with the vehicle 2 according to the schedule are accumulated as the probability P3, and learning progresses. The latest value of the probability P3 corresponding to the estimated day is read out, and the weighting coefficient γ is accumulated and used for the calculation of the above probability P.

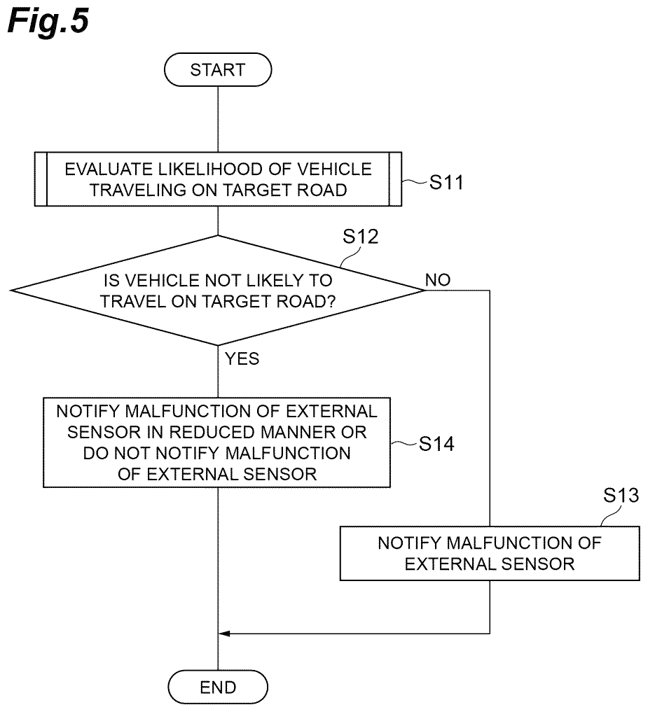

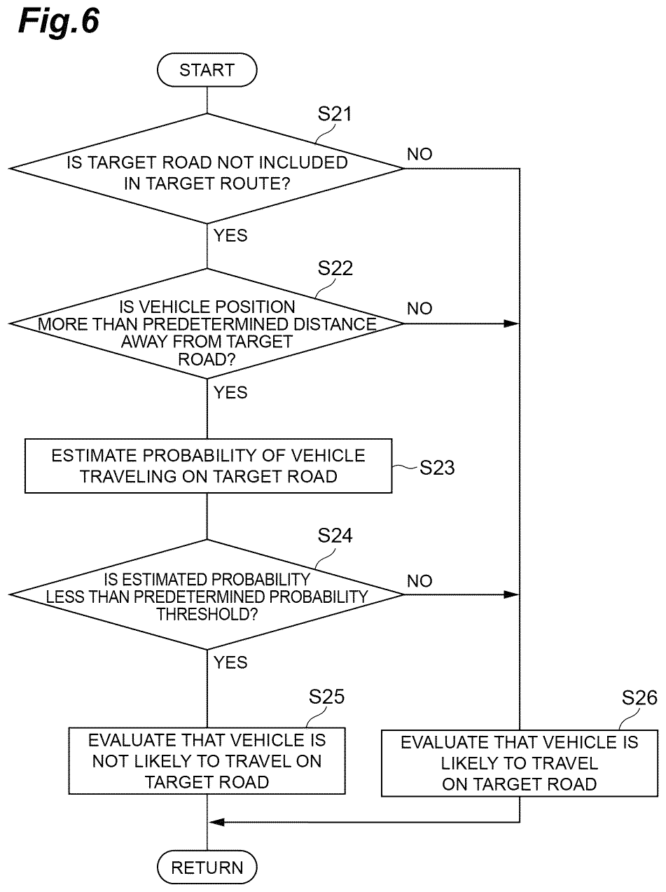

Next, the processing of the notification device 1 will be described with reference to FIG. 5 and FIG. 6. FIG. 5 is a flowchart showing an example of processing of the notification device. The flowchart shown in FIG. 5 is executed, for example, from when a malfunction of the external sensor 4 is recognized and is repeatedly executed at a predetermined cycle.

As shown in FIG. 5, the autonomous driving ECU 10 of the notification device 1 evaluates the likelihood that the vehicle 2 travels on the target road as S11. The autonomous driving ECU 10 may perform the processing shown in FIG. 6 as the likelihood evaluation processing.

FIG. 6 is a flowchart showing an example of the likelihood evaluation processing of FIG. 5.

As shown in FIG. 6, the autonomous driving ECU 10 determines whether or not the target road is included in the target route by the notification control unit 14 as S21. The notification control unit 14 proceeds to the processing of S22 when the set target route is not included in the motorways as the ODD (S21: YES). The notification control unit 14 proceeds to the processing of S26 when the set target route is included in the motorways as the ODD (S22: NO).

In S22, the autonomous driving ECU 10 determines whether or not the position of the vehicle 2 is at or more than a predetermined distance threshold away from the target road by the notification control unit 14. The notification control unit 14 proceeds to the processing of S23 when the vehicle position of the vehicle 2 is at or more than a predetermined distance threshold away from the interchange of the motorways (S22: YES). The notification control unit 14 proceeds to the processing of S26 when the vehicle position of the vehicle 2 is not at or more than a predetermined distance threshold away from the interchange of the motorways (S22: NO).

In S23, the autonomous driving ECU 10 estimates the probability that the vehicle 2 travels on the target road by the notification control unit 14. The notification control unit 14 calculates the above-mentioned probabilities P1 to P3 based on past travel history and estimates the probability P that the vehicle 2 travels on the motorways according to the above formula (1).

In S24, the autonomous driving ECU 10 determines whether or not the estimated probability P is less than a predetermined probability threshold by the notification control unit 14. The notification control unit 14 proceeds to the processing of S25 when the estimated probability P is less than the predetermined probability threshold (S24: YES). The notification control unit 14 proceeds to the processing of S26 when the estimated probability P is at or more than the predetermined probability threshold (S24: NO).

In S25 and S26, the autonomous driving ECU 10 evaluates the likelihood that the vehicle 2 travels on the target road by the notification control unit 14. In S24, the notification control unit 14 evaluates that the vehicle 2 is not likely to travel on the target road (motorways). In S25, the notification control unit 14 evaluates that the vehicle 2 is likely to travel on the target road. Thereafter, the processing of FIG. 6 is ended and the process returns to FIG. 5.

Returning to FIG. 5, the autonomous driving ECU 10 determines whether or not the vehicle 2 is not likely to travel on the target road by the notification control unit 14 as S12. The notification control unit 14 proceeds to the processing of S14 when it is determined that the vehicle 2 is not likely to travel on the target road (S12: YES). The notification control unit 14 proceeds to the processing of S13 when it is determined that the vehicle 2 is likely to travel on the target road (S12: NO).

In S13, the autonomous driving ECU 10 notifies the malfunction of the external sensor 4 in a normal manner without suppression by the notification control unit 14. The notification control unit 14 may perform a pop-up display including text information such as “Autonomous driving is not available. System malfunction” on the speedometer screen of the HMI 8 when a malfunction of the external sensor 4 is recognized. Thereafter, the processing of FIG. 5 is ended.

In S14, the autonomous driving ECU 10 notifies the malfunction of the external sensor 4 in a reduced manner compared to the processing of S13 by the notification control unit 14. The notification control unit 14 may perform an indicator display using a predetermined icon representing a malfunction of the external sensor 4 on the display of the HMI 8 when a malfunction of the external sensor 4 is recognized. Alternatively, the notification control unit 14 may not notify the malfunction of the external sensor 4. Thereafter, the processing of FIG. 5 is ended.

As described above, in the notification device 1, when the vehicle 2 is not likely to travel on the target road, the malfunction of the external sensor 4 is notified in a reduced manner, or the malfunction of the external sensor 4 is not notified. This suppresses the notification of malfunctions of the external sensor 4 even though the vehicle 2 is not likely to travel on the target road. As a result, it is possible to suppress causing annoyance and anxiety to the occupant due to temporary malfunctions of the external sensor 4.

In the notification device 1, the notification control unit 14 evaluates that the vehicle is not likely to travel on the target road when the target road is not included in the target route, or when the vehicle position is at or more than a predetermined distance threshold away from the target road. This makes it possible to evaluate the likelihood of the vehicle traveling on the target road based on whether or not the target road is included in the target route, or whether or not the vehicle position is at or more than a predetermined distance threshold away from the target road.

In the notification device 1, the notification control unit 14 estimates, based on past travel history, the probability that the vehicle 2 travels on the target road at a timing corresponding to the same day and time period of the week, and evaluates that the vehicle 2 is not likely to travel on the target road when the estimated probability is less than a predetermined probability threshold. This makes it possible to evaluate the likelihood of the vehicle 2 traveling on the target road according to the probability that the vehicle 2 travels on the target road at a timing corresponding to the same day and time period of the week.

In the notification device 1, the notification control unit 14 estimates, based on past travel history, the probability that the vehicle 2 travels on the target road at a corresponding timing during a holiday period, and evaluates that the vehicle 2 is not likely to travel on the target road when the estimated probability is less than a predetermined probability threshold. This makes it possible to evaluate the likelihood of the vehicle 2 traveling on the target road according to the probability that the vehicle 2 travels on the target road at a corresponding timing during a holiday period.

In the notification device 1, the notification control unit 14 estimates, based on schedule information including a destination of the occupant obtainable from an information terminal carried by the occupant, the probabilities P1, P2, and P3 that the vehicle 2 travels on the target road along the target route to the destination, and evaluates that the vehicle 2 is not likely to travel on the target road when the probability P calculated from the probabilities P1, P2, and P3 is less than a predetermined probability threshold. This makes it possible to evaluate the likelihood of the vehicle 2 traveling on the target road by utilizing schedule information including the destination.

[Modifications] Although various examples have been described above, various omissions, substitutions, and changes may be made without departing from the scope of the exemplary examples described above.

For example, in the above example, the probabilities P1, P2, and P3 that the vehicle 2 travels on the target road along the target route to the destination are estimated, and the probability P is calculated from the probabilities P1, P2, and P3 according to the above formula (1), but the evaluation of the likelihood is not limited to this. For example, one or two of the probabilities P1, P2, and P3 may be omitted from the calculation of the probability P, or the calculation of the probability P may be omitted, and one of the probabilities P1, P2, and P3 may be compared with the probability threshold.

In the above example, the probabilities P1, P2, and P3 are calculated by a learning method as in the examples of FIG. 2A to FIG. 4, but the present disclosure is not limited to this. The learning of the probability that the vehicle 2 travels on the target road and the estimation of the probability may use other information (for example, past weather history, etc.).

In the above example, motorways such as Interstate Highways, Freeways, and Expressways are exemplified as the ODD, but the present disclosure is not limited to this. Other types of ODD include general national roads, prefectural roads, municipal roads, private roads, and the like. The notification control unit 14 may notify the malfunction of the external sensor 4 in a reduced manner when the vehicle 2 is located outside the selected ODD at that time, for example, when the ODD is a variable type in which different types are selected from among the ODD types depending on the time period or environment. For example, at night (time period) or in rainy weather (environment), only motorways may be selected as the ODD, and general national roads including exclusive roads for automobiles may be non-selected. In addition, a part of the above road types may be individually set as the ODD. Specifically, a part of the road where curves or slopes are steep, visibility is poor, or troubles are expected to be frequent may be non-selected as the ODD.

In the above example, the malfunction of the external sensor 4 is treated uniformly, but whether or not to notify the malfunction of the external sensor 4 in a reduced manner may be switched depending on the type of the external sensor 4 and the target road, even if the target road is included in the ODD. For example, in a vehicle where a LiDAR is necessary for traveling on motorways and unnecessary for traveling on general national roads, when the LiDAR is malfunctioning, the malfunction of the LiDAR may be notified in a non-reduced manner while traveling on the motorways, and may be notified in a reduced manner while traveling on the general national road, even if the general national road is included in the ODD.

In addition to the above example, the notification control unit 14 may notify the malfunction of the external sensor 4 in a reduced manner even when the target road is included in the ODD, when the vehicle state does not allow the start of driving assistance control or autonomous driving control. For example, when the vehicle 2 is in the P range state on the shoulder of a general road included in the ODD, or when the vehicle speed of the vehicle 2 exceeds the upper limit vehicle speed at which driving assistance control or autonomous driving control can be executed, the malfunction of the external sensor 4 may be notified in a reduced manner even if the target road is included in the ODD.

The probability threshold may be set to an arbitrary value by the occupant via the HMI 8. The probability threshold may be selected by the occupant via the HMI 8 from among multiple stages (for example, low probability, medium probability, high probability). The probability threshold may be varied by weather or time period. Specifically, in bad weather or at night, the probability threshold may be changed to a smaller value to make the malfunction of the external sensor 4 as non-reduced as possible. In addition, as the travel distance of the vehicle 2 increases and the driver becomes accustomed to driving assistance control or autonomous driving control, the probability threshold may be changed to a larger value to make the malfunction of the external sensor 4 more likely to be notified in a reduced manner. The probability threshold may be different for each autonomous driving level among autonomous driving levels 2 to 4, for example. Specifically, in a configuration where autonomous driving levels 2 and 3 can be switched and used, the probability threshold of autonomous driving level 3 may be set to a smaller value than the probability threshold of autonomous driving level 2 to make the malfunction of the external sensor 4 as non-reduced as possible.

The following describes the constituent requirements of various aspects of the present disclosure.
[1] A notification device of a vehicle capable of executing driving assistance control or autonomous driving control on a target road, comprising:
   a malfunction recognition unit configured to recognize a malfunction of an external sensor used for the driving assistance control or the autonomous driving control; and
   a notification control unit configured to notify an occupant of the vehicle about the malfunction of the external sensor when a malfunction of the external sensor is recognized; wherein
   the notification control unit
      evaluates whether the vehicle is likely to travel on the target road based on a vehicle position, a target route, or a travel history of the vehicle; and
      when the vehicle is not likely to travel on the target road, notifies the occupant of the vehicle about the malfunction of the external sensor in a reduced manner compared to a manner when the vehicle is likely to travel on the target road, or does not notify the occupant of the vehicle about the malfunction of the external sensor.
[2] The notification device according to [1], wherein
   the notification control unit evaluates that the vehicle is not likely to travel on the target road when the target road is not included in the target route, or when the vehicle position is at or more than a predetermined distance threshold away from the target road.
[3] The notification device according to [1] or [2], wherein
   the notification control unit estimates, based on past travel history, a probability that the vehicle travels on the target road at a timing corresponding to the same day and time period of the week, and evaluates that the vehicle is not likely to travel on the target road when the probability is less than a predetermined probability threshold.
[4] The notification device according to any one of [1] to [3], wherein
   the notification control unit estimates, based on past travel history, a probability that the vehicle travels on the target road at a corresponding timing during a holiday period, and evaluates that the vehicle is not likely to travel on the target road when the probability is less than a predetermined probability threshold.
[5] The notification device according to any one of [1] to [4], wherein
   the notification control unit estimates, based on schedule information including a destination of the occupant obtainable from an information terminal carried by the occupant, a probability that the vehicle travels on the target road along the target route to the destination, and evaluates that the vehicle is not likely to travel on the target road when the probability is less than a predetermined probability threshold.

What is claimed is:

1. A notification device of a vehicle capable of executing driving assistance control or autonomous driving control on a target road, comprising:
a malfunction recognition unit configured to recognize a malfunction of an external sensor used for the driving assistance control or the autonomous driving control; and
a notification control unit configured to notify an occupant of the vehicle about the malfunction of the external sensor when a malfunction of the external sensor is recognized; wherein
the notification control unit
evaluates whether the vehicle is likely to travel on the target road based on a vehicle position, a target route, or a travel history of the vehicle; and
when the vehicle is not likely to travel on the target road, notifies the occupant of the vehicle about the malfunction of the external sensor in a reduced manner compared to a manner when the vehicle is likely to travel on the target road, or does not notify the occupant of the vehicle about the malfunction of the external sensor.

2. The notification device according to claim 1, wherein
the notification control unit evaluates that the vehicle is not likely to travel on the target road when the target road is not included in the target route, or when the vehicle position is at or more than a predetermined distance threshold away from the target road.

3. The notification device according to claim 1, wherein
the notification control unit estimates, based on past travel history, a probability that the vehicle travels on the target road at a timing corresponding to the same day and time period of the week, and evaluates that the vehicle is not likely to travel on the target road when the probability is less than a predetermined probability threshold.

4. The notification device according to claim 1, wherein
the notification control unit estimates, based on past travel history, a probability that the vehicle travels on the target road at a corresponding timing during a holiday period, and evaluates that the vehicle is not likely to travel on the target road when the probability is less than a predetermined probability threshold.

5. The notification device according to claim 1, wherein
the notification control unit estimates, based on schedule information including a destination of the occupant obtainable from an information terminal carried by the occupant, a probability that the vehicle travels on the target road along the target route to the destination, and evaluates that the vehicle is not likely to travel on the target road when the probability is less than a predetermined probability threshold.
